(19) United States
(12) Patent Application Publication
(10) Pub. No.: US 2016/0042843 A1
(43) Pub. Date: Feb. 11, 2016

(54) Electric Fence Insulator Having Indicator Light

(71) Applicant: Craig Richard, Rolette, ND (US)

(72) Inventor: Craig Richard, Rolette, ND (US)

(21) Appl. No.: 14/813,960

(22) Filed: Jul. 30, 2015

Related U.S. Application Data
(60) Provisional application No. 62/033,781, filed on Aug. 6, 2014.

(51) Int. Cl. H01B 17/14; G08B 5/36

(52) U.S. Cl. CPC H01B 17/145; G08B 5/36

(57) ABSTRACT

An electric fence insulator for indicating whether electric current is flowing through an electric fence wire supported thereon. The electric fence insulator includes a bracket for securement to a fence post and a wire support for holding a length of electric fence wire. The bracket comprises an opening through which a fence post may be inserted and further includes a removable securing member for securing the bracket in a desired position on the fence post. The wire support includes an indicator light thereon that illuminates when an electric fence wire having current running therethrough is in contact with an electrical contact plate that is electrically connected to the indicator light. In this way, the illumination of the lights allows a person to determine from a distance whether current is flowing through an electric fence wire or if all or a portion of the electrical circuit has shorted.

### CROSS REFERENCE TO RELATED APPLICATION

This application claims the benefit of U.S. Provisional Application No. 62/033,781 filed on Aug. 6, 2014. The above identified patent application is herein incorporated by reference in its entirety to provide continuity of disclosure.

### BACKGROUND OF THE INVENTION

1. Field of the Invention

The present invention relates to an electric fence insulator. More specifically, the present invention provides an electric fence insulator for holding a length of electric fence wire, wherein an indicator light thereon illuminates if electrical current is running through the fence wire, allowing a user to easily determine if an electric fence is functioning properly.

Cattle and other livestock are often restricted to a pasture or field by means of an electric fence. The electric fence includes a plurality of electrically conducting wires having an electric current running therethrough. If the livestock contact the fence wires, the livestock will receive an electric shock, preventing the livestock from leaving the area defined by the fence and discouraging the livestock from trying to break through the fence.

In spite of the electric fence, livestock may occasionally break or damage one or more fence wires, decreasing the effectiveness of the electric fence. Further, weather conditions and growth of vegetation on the fence posts may damage the fence or otherwise decrease its effectiveness by creating an electrical short. As a result, the damaged electric fence may be ineffective in restraining other livestock. However, it can be difficult to determine if the electric fence is damaged, particularly from a distance. Thus, a device that allows a user to easily determine if an electric fence is damaged, or if an electrical fence wire has shorted, is desired.

2. Description of the Prior Art

Devices have been disclosed in the prior art that relate to electrical power line signaling devices. These include devices that have been patented and published in patent application publications. These devices generally relate to electric fence signals or indicators. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 4,259,545 to Hayden discloses a high voltage insulator for providing a means for indicating whether an electric power line is energized. A conventional insulator is provided with a glow lamp or fluorescent indicator which illuminates when the conductor is energized. The device includes a dome filled with gas for either fluorescent or neon illumination. The interior of the gas chamber is connected to the exterior via a conductor that can energize the gas by means of the electrostatic field of a high voltage power line. Thus, Hayden provides a high voltage insulator for power lines, and fails to disclose an electric fence insulator including means for securement to a fence post and further including an illuminable light, such as an LED.

Another device, U.S. Pat. No. 4,171,523 to Parkitny discloses a signal light for electric fences. The signal lights are adapted to be placed on one or more posts of an electric fence. The lights indicate whether electric charge is flowing through the electric wire at full charge, partial charge, or no charge. While Parkitny discloses a signal light for electric fences, Parkitny fails to disclose an electric fence insulator having a bracket that can be secured to a fence post via a pair of arms adapted to receive a securing member thereon via a threaded engagement.

U.S. Pat. No. 2,429,764 to Moore discloses an electric fence indicator. The device comprises a housing having an insulated fence terminal and a ground terminal thereon. A fence wire is adapted to be connected to the fence terminal while the ground terminal is connected in any manner to the ground. The housing includes an adjustable knob that control a switch that determines the voltage impressed upon the fence wire. The housing further includes one or more glow lamps thereon. Thus, Moore does not disclose an electric fence insulator adapted to support an electrical fence wire thereon and that illuminates to indicate that current is supplied to the wire.

U.S. Pat. No. 4,725,825 to McKean discloses an electric fence voltage indicator light. McKean provides a storage device adapted to be coupled to the electric fence for storing energy pulses present on the fence and further including a light emitter sensitive to voltage values of the energy pulses. Thus, McKean fails to disclose an electric fence insulator adapted to support a portion of an electric fence and that is removably securable to a fence post by means of a bracket and a securing member removably securable thereto via a threaded engagement.

U.S. Pat. No. 3,648,266 to Crist discloses an electric fence short detector. When the electric fence is shorted, a current impulse is provided in a coil of the device that causes a core to be magnetized to attract an armature. The contact of the core and the armature completes an internal circuit, activating an indicator device. Thus, Crist fails to disclose an electric fence insulator that supports an electrical fence wire and that is removably securable to an electric fence post.

Finally, U.S. Pat. No. 2,026,770 to Bergman discloses a signal for marking the position and condition of a transmission line. The signal helps aviators to locate transmission lines during the night and during times of poor visibility. A luminous signal is fastened to the transmission tower or to the conductors of a transmission line, and the signal is lighted by the potential on the transmission line. Thus, Bergman discloses a light for helping users to determine the location of a power line and does not disclose a device for supporting an electrical fence wire.

These prior art devices have several known drawbacks. The devices in the prior art generally relate to devices for indicating the condition of a power line or electric fence wire. However, the devices in the prior art fail to disclose a device that is adapted to support a portion of an electric fence wire and instead disclose devices securable to an electric fence wire, or that are removably connected.

In light of the devices disclosed in the prior art, it is submitted that the present invention substantially diverges in design elements from the prior art and consequently it is clear that there is a need in the art for an improvement to existing electric fence insulating devices. In this regard the instant invention substantially fulfills these needs.

### SUMMARY OF THE INVENTION

In view of the foregoing disadvantages inherent in the known types of electric fence insulators now present in the prior art, the present invention provides a new electric fence insulator wherein the same can be utilized for providing convenience for the user when allowing a user to easily determine if an electric fence is damaged or shorted.

It is therefore an object of the present invention to provide a new and improved electric fence insulator device that has all of the advantages of the prior art and none of the disadvantages.

It is another object of the present invention to provide an electric fence insulator having a light thereon that illuminates when an electric fence wire having current running therethrough is in contact therewith.

Another object of the present invention is to provide an electric fence insulator removably securable to a fence post by means of a bracket thereon.

Yet another object of the present invention is to provide an electric fence insulator having a wire support adapted to contact a length of an electric fence wire.

Another object of the present invention is to provide an electric fence insulator that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the electric fence insulator of the present invention.

FIG. 2 shows a side perspective view of an embodiment of the electric fence insulator of the present invention.

FIG. 3 shows a top down view of the electric fence insulator of the present invention.

FIG. 4 shows a frontal view of an embodiment of the electric fence insulator in use.

### DETAILED DESCRIPTION OF THE INVENTION

Reference is made herein to the attached drawings. Like reference numerals are used throughout the drawings to depict like or similar elements of the electric fence insulator. For the purposes of presenting a brief and clear description of the present invention, the preferred embodiment will be discussed as used for supporting an electric fence wire and indicating whether current is running therethrough. The figures are intended for representative purposes only and should not be considered to be limiting in any respect.

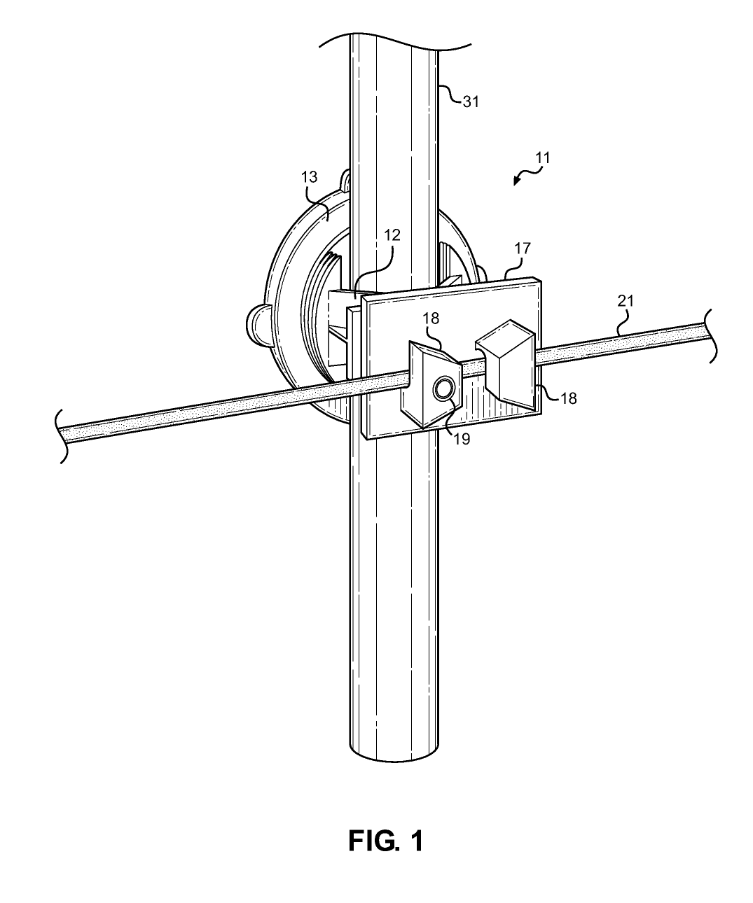

Referring now to FIG. 1, there is shown a perspective view of an embodiment of the electric fence insulator of the present invention. The electric fence insulator 11 comprises a wire support 17 removably securable to a fence post by means of a bracket 12 secured thereto. The wire support 17 comprises a planar member having one or more fingers 18 extending therefrom. Preferably, there is a pair of fingers 18 that are in horizontal alignment on the planar member. The planar member is oriented in a vertical plane and the fingers 18 extend perpendicularly therefrom. The fingers 18 are adapted to hold a portion of an electric fence wire 21 so as to support the electric fence wire 21 in the proper position and so as to maintain the tension in the wire 21. A first finger 18 provides a lower constraint on the wire 21 while the second finger 18 provides an upper constraint on the wire 21. In this way, the wire cannot slip or be easily removed from the fingers 18.

At least one indicator light 19 is positioned on the wire support 17, and is preferably positioned on a finger 18. The indicator light 19 is adapted to illuminate when current is supplied through the wire 21 held by the electric fence insulator 11. One of the fingers 18 includes an electrically conducting plate that the electric fence wire 21 contacts when supported by the finger 18. The electrically conducting plate conducts electricity and is electrically connected to the indicator light 19. Additional circuitry is provided so as to deliver the appropriate current and voltage to the indicator light 19. If no current is running through the wire 21, the indicator light 19 will fail to illuminate, indicating that the wire is damaged or that power is otherwise not flowing through the wire 21. This allows a user to easily visually inspect whether an electric fence is functioning properly.

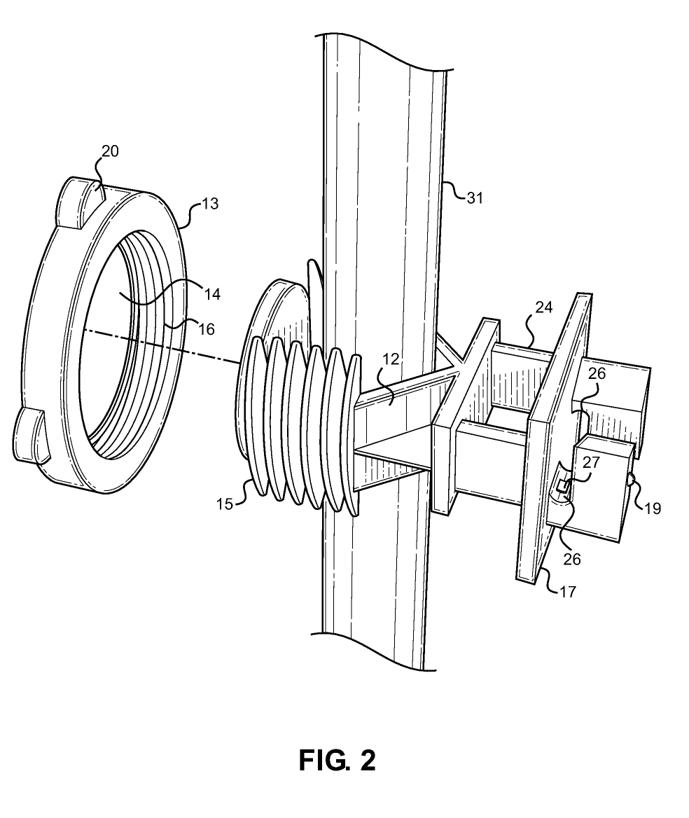

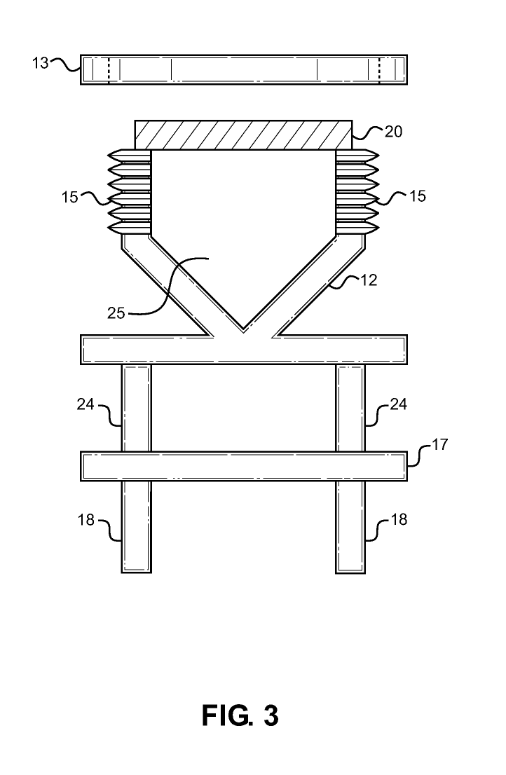

Referring now to FIGS. 2 and 3, there is shown a side perspective view of the electric fence insulator and a top down view of the electric fence insulator. The fence post insulator 11 is secured to a fence post by means of the bracket 12. The bracket 12 comprises a pair of arms 15 connected by an end member 20, defining an opening 25 in which a fence post 31 can be positioned. Thus, the device can be lowered over the top of a fence post 31 and adjusted to the desired elevation thereon.

With the bracket 12 disposed at the desired the arms 15 of the bracket 12 are positioned on opposing sides of the fence post 31 and the wire support 17 is oriented vertically. To secure the device 11 to the fence post 31, the user can engage a securing member 13 with the arms 15 of the bracket 12. The securing member 13 preferably comprises an annular member having a central opening 14 and a threaded interior surface 16. The arms 15 include threading thereon such that the arms 15 and the threaded interior surface 16 of the securing member 13 can be removably engaged. The user can adjustably tighten the securing member 13 until the device is securely positioned on the fence post 31. Further, an exterior surface of the securing member 13 includes one or more protrusions 17 thereon for helping a user to grasp and manipulate the securing member 13.

In the illustrated embodiment, the wire support 17 is separated from the bracket 12 by a pair of spacers 24. However, in alternate embodiments, the wire support 17 may be secured directly to the bracket 12. The spacers 24 help to separate an electric fence wire supported by the fingers 18 from the fence post. This helps to prevent the fence wire from contacting the fence post in the event that the wire is bent or otherwise damaged. If the wire contacts the fence post, an electrical short may be created, decreasing the voltage through the wire, and thus decreasing the effectiveness of the fence in retaining animals.

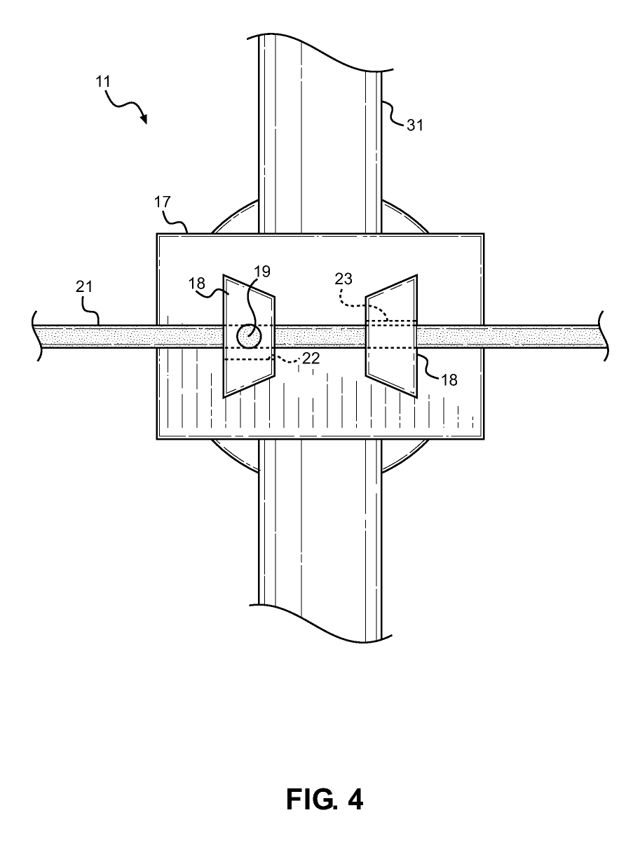

Referring now to FIG. 4, there is shown a frontal view of an embodiment of the electric fence insulator in use. The electric fence insulator 11 comprises a planar member 17 having one or more fingers 18 extending therefrom. Preferably, a pair of fingers 18 is included, wherein the fingers 18 are in horizontal alignment and are separated by a space. The pair of fingers 18 are adapted to support the electric fence wire 21 in a horizontal orientation, and prevents the electric fence wire 21 from sagging. Each finger 18 includes a channel 26 through which a portion of the electric fence wire 21 can extend. In the channel 26, the electric fence wire is restrained from forward movement by the finger 18 and is restrained from rearward movement by the planar member 17. Further, a first finger 18 defines a lower restraint 22 preventing the fence wire 21 from sagging, and a second finger 18 defines an upper restraint 23, preventing the fence wire 21 from being lifted or elevated. The lower and upper restraints 22, 23 help to maintain the position of the electric fence wire 21 and prevent the electric fence wire 21 from being removed from the electric fence insulator 11.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electric fence insulator, comprising:
a bracket adapted to be secured to an electric fence post;
a wire support affixed to said bracket;
said wire support having one or more fingers adapted to support an electric fence wire thereon;
an indicator light adapted to illuminate when electrical current is supplied through said electric fence wire.

2) The electric fence insulator of claim 1, wherein said bracket comprises a pair of arms and an end member connected said pair of arms, defining an opening in which said electric fence post can be positioned.

3) The electric fence insulator of claim 2, further comprising a securing member removably securable to said pair of arms.

4) The electric fence insulator of claim 2, wherein said securing member comprises an annular ring having a threaded interior surface adapted to removably engage with threading on said pair of arms.

5) The electric fence insulator of claim 1, wherein said wire support comprises a planar member having said one or more fingers extending therefrom.

6) The electric fence insulator of claim 1, wherein said one or more fingers comprises a pair of fingers in horizontal alignment.

7) The electric fence insulator of claim 1, further comprising an electrically conducting plate positioned on said one or more fingers, wherein said electrically conducting plate is in electrical connection with said indicator light, such that electrical current flowing through said electric fence wire in contact with said electrically conducting plate causes said indicator light to illuminate.
